(19) United States
(12) Patent Application Publication
(10) Pub. No.: US 2008/0197592 A1
(43) Pub. Date: Aug. 21, 2008

(54) HAND TRUCK

(76) Inventor: Stephen A. Dukes, North Baltimore, OH (US)

Correspondence Address: FRASER CLEMENS MARTIN & MILLER LLC, 28366 KENSINGTON LANE, PERRYSBURG, OH, 43551, US

(21) Appl. No.: 12/026,204

(22) Filed: Feb. 5, 2008

Related U.S. Application Data
(60) Provisional application No. 60/890,091, filed on Feb. 15, 2007.

(51) Int. Cl. B62B 3/00

(52) U.S. Cl. 280/47.34

(57) ABSTRACT

A hand truck is disclosed, the hand truck including a dual-positionable handle assembly, a plurality of casters, and a main body adapted to receive a portion of the handle assembly, wherein the main body includes a pocket adapted to receive a portion of a hand of a user to facilitate carrying the hand truck.

### CROSS-REFERENCE TO RELATED APPLICATION

This application claims the benefit of provisional patent application No. 60/890,091 filed Feb. 15, 2007.

### FIELD OF THE INVENTION

The invention relates to a hand truck adapted to transport items and more particularly to a hand truck having a dual-positionable handle for selectively pushing, pulling, carrying, or storing the hand truck.

### BACKGROUND OF THE INVENTION

Typically, hand trucks include a substantially rectangular and flat main body adapted to support items placed on the hand truck. The hand truck is maneuvered by casters disposed on a bottom thereof and by handles permanently positioned in an upright or substantially vertical position.

Because the handles of the hand trucks are permanently fixed in a vertical position, when a user is pushing or pulling the hand truck their feet may collide with an end of the hand truck. Further, because the handle is fixed to the hand truck, the hand truck is not compact and cannot be easily stored.

Other typical hand trucks include removable handles to accommodate storage. Removal of the handle requires extra mechanical steps of disassembly and reassembly of the handle with the hand truck. Also, removal of the handle requires storage of both the handle and hand truck. Other hand trucks include handles adopted to fold down on the main body, thereby increasing the overall height and size of the hand truck when stored. Furthermore, when the handle is in a folded position the hand truck is more difficult to maneuver for storage.

Another problem with conventional hand trucks relates to the casters and mounting of the casters to the hand truck. Usually the hand truck includes rear casters adjacent to the handle and front casters adjacent a front of the hand truck. Typically the rear casters are fully rotatable while the front casters are either fully rotatable or unidirectional. Such configurations of the hand truck do not allow the user the option of having either rotatable or unidirectional front casters, the latter being desirable for providing increased steering stability when encountering heavier loads and the former being preferable for lighter loads. Furthermore, brackets adapted to attach the casters to the surface of the hand truck are typically mounted to the surface parallel to an edge of the surface.

### SUMMARY OF THE INVENTION

A hand truck including a dual-positionable handle assembly, a plurality of casters, and a main body adapted to receive a portion of the handle assembly, wherein the main body includes a pocket adapted to receive a portion of a hand of a user to facilitate carrying of the hand truck, has surprisingly been discovered.

### BRIEF DESCRIPTION OF THE DRAWINGS

The above and other advantages of the invention will become readily apparent to those skilled in the art from reading the following detailed description of the invention when considered in the light of the accompanying drawings, in which:

FIG. 1 is a perspective view of a hand truck with a handle in a first position according to an embodiment of the invention;

FIG. 2 is a top elevational view of the hand truck of FIG. 1 with the handle in a second position; and

FIG. 3 is a bottom elevational view of the hand truck illustrated in FIGS. 1 and 2.

### DETAILED DESCRIPTION OF THE PREFERRED EMBODIMENTS OF THE INVENTION

The following detailed description and appended drawings describe and illustrate various exemplary embodiments of the invention. The description and drawings serve to enable one skilled in the art to make and use the invention, and are not intended to limit the scope of the invention in any manner.

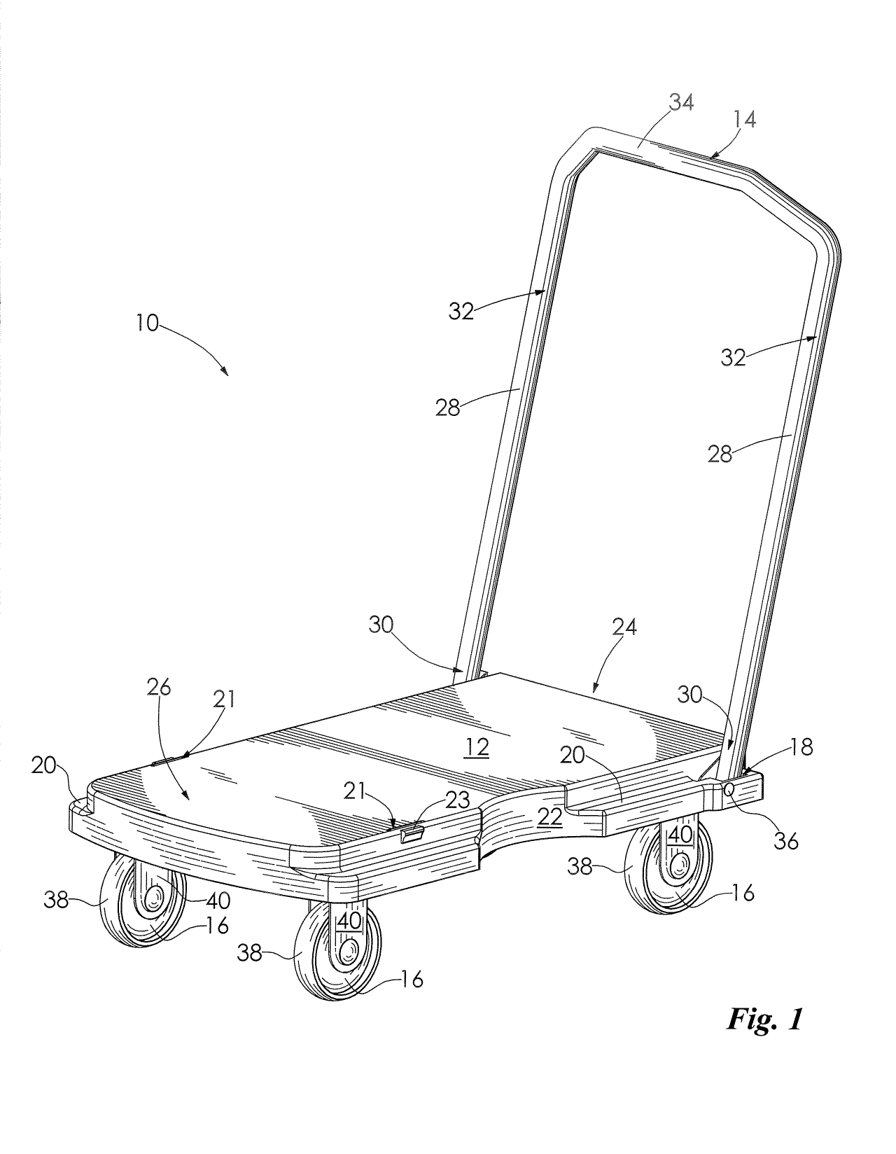

Referring to FIGS. 1-3 there is illustrated a hand truck 10. The hand truck 10 includes a main body 12, a handle assembly 14, and a plurality of casters 16. As shown in FIGS. 1-3, the main body 12 has a substantially planar upper surface and a substantially rectangular shape. However, the main body can have any shape as desired such as circular, ovoid, square, triangular, or trapezoidal, for example. Additionally, the main body 12 is shown as formed from a composite material, but may be formed from any conventional material such as a polymer, a metal, or wood, for example.

A pair of spaced apart apertures 18 is formed in a first end 24 of the main body 12. The apertures 18 are adapted to receive a portion of the handle assembly 14. Channels 20 are formed on opposite sides of the main body 12 and extend an entire length thereof. The channels 20 are adapted to receive at least a portion of the handle assembly 14 when in a folded position. In the embodiment shown, the channels 20 have a substantially u-shaped cross-section. However, the channels 20 may have any cross-sectional shape adapted to receive the handle assembly 14, as desired. Slots 21 are formed adjacent the channels 20 with a détente 23 disposed adjacent thereto. A pocket 22 is formed in one of the channels 20. In the embodiment shown, the pocket 22 has a substantially crescent shape. The pocket 22 may have any shape such as round, rectangular, ovoid, or trapezoidal, for example. It is understood that the pocket 22 may be formed adjacent either or both of the channels 20, or at the second end 26 of the hand truck 10.

The handle assembly 14 includes a pair of spaced apart and substantially parallel arms 28. The arms 28 have a first end 30 and a second end 32. A handle portion or gripping portion 34 is disposed at the second end 32 of the arms 28, and is substantially perpendicular to the arms 28. The first ends 30 of the arms 28 are pivotally disposed in the apertures 18 of the main body 12. It is understood that the first ends 30 of the arms 28 of the handle assembly 14 may be pivotally attached to the main body 12 by any conventional means such as a pin, a bolt, or a screw, for example. In the embodiment shown, the handle assembly 14 is substantially unshaped and angled toward the second end 26 of the hand truck 10 when in an upright position. It is understood that the handle assembly 14 may have any shape and may be disposed at any angle relative to the main body 12, as desired. In the embodiment shown, the arms 28 and handle portion 34 are integrally formed. However, the arms 28 and the handle portion 34 may be separately formed and assembled together, as desired. It is understood that the arms 28 may be angled in relation to one another, rather than substantially parallel. As shown, the handle assembly 14 is formed from a metal, but may be formed from any conventional material such as a polymer, wood, or a composite, for example.

The casters 16 are disposed on a bottom of the main body 12 of the hand truck 10. Each of the casters 16 includes a wheel 38 and a bracket 40 adapted to be attached to the bottom of the hand truck 10. A first caster 16a and a second caster 16b are disposed on the first end 24 of the hand truck 10, and the wheels thereof are adapted to pivot relative to the brackets 40. The brackets 40 of the first caster 16a and the second caster 16b are disposed on the bottom of the main body 12 at an angle relative to a longitudinal axis of the main body 12. A third caster 16c and a fourth caster 16d are disposed on the second end 26 of the hand truck 10 and are adapted to be unidirectional. It is understood that the casters 16a, 16b, 16c, and 16d may be any combination of unidirectional and multidirectional, as desired. It is also understood that a combination of the casters 16a, 16b, 16c, 16d may be disposed on the bottom parallel to the longitudinal axis of the main body 12, or that a combination of the casters 16a, 16b, 16c, 16d may be disposed on the bottom at any angle relative to the longitudinal axis of the main body 12, as desired.

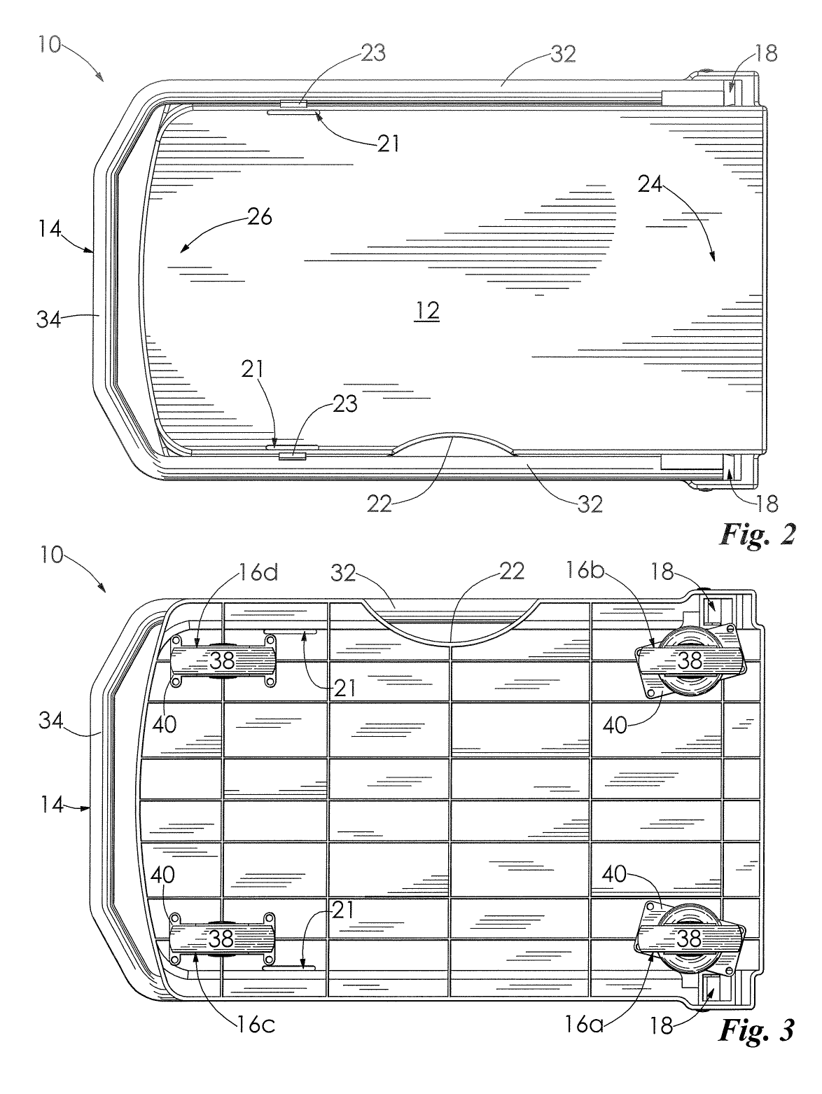

In use, the handle assembly 14 of the hand truck 10 may be disposed in a first or operating position as shown in FIG. 1, or a second or stored position as shown in FIG. 2. In the first position, the arms 28 of the handle assembly 14 are offset slightly from perpendicular to the main body 12 of the hand truck 10. A portion (not shown) of the first ends 30 of the arms 28 cooperate with a portion (not shown) of the main body 12 forming the apertures 18 to militate against rotational movement of the arms 28 when the hand truck 10 is in use in the first position. A user may push or pull the hand truck 10 by gripping the handle portion 34 of the handle assembly 14. By pushing or pulling the hand truck 10 with the handle assembly 14 in the first position, the user causes the wheels 38 of the casters 16 to roll, thereby transporting the hand truck 10 and any items (not shown) disposed thereon.

In the second position, the arms 28 of the handle assembly 14 are disposed in the channels 20 of the hand truck 10. The user may minimize a space the hand truck 10 occupies for storage purposes, or a user may carry the hand truck 10 for easier transportation or though small spaces, as desired. To carry the hand truck 10, the user grasps the arm 28 adjacent the pocket 22. The pocket 22 is adapted to provide space for the user's hand when the hand truck 10 is carried.

To transition the handle assembly 14 from the first position to the second position, the user initially pulls the handle assembly 14 upwardly away from the main body 12 to move the handle assembly 14 from a locked position to an unlocked position. The handle assembly 14 is then rotated downwardly toward the main body 12. Once the arms 28 of the handle assembly 14 abut the détentes 23, the user provides an additional force on the handle assembly 14 to cause the arms 28 to deflect the détentes 23 inwardly toward the slots 21. Once the arms 28 of the handle assembly 14 have passed the détentes 23, the détentes 23 deflect outwardly to the original position and militate against movement of the handle assembly 14 to releasably store the handle assembly 14 and facilitate carrying the hand truck 10. To transition the handle assembly 14 from the second position to the first position, the user must pull upwardly on the handle assembly 14 with a sufficient force to cause the détentes 23 to deflect inwardly, until the arms 28 of the handle assembly 14 pass over the détentes 23. Once in a substantially upright position, the handle assembly 28 is moved to the locked position.

From the foregoing description, one ordinarily skilled in the art can easily ascertain the essential characteristics of this invention and, without departing from the spirit and scope thereof, can make various changes and modifications to the invention to adapt it to various usages and conditions in accordance with the scope of the appended claims.

What is claimed is:

1. A hand truck comprising:
a main body having a substantially planar upper surface, a pair of spaced apart apertures formed in a first end of said main body, a pair of spaced apart channels formed on opposing sides of the upper surface, a pocket formed in said main body adjacent one of the channels, and at least three casters disposed on a bottom of said main body, wherein a first pair of said casters is disposed on the first end of said main body; and
a handle assembly including a pair of spaced apart arms joined by a handle portion, wherein each of the arms includes a first end pivotally disposed in one of the apertures of said main body, said handle assembly adapted to be selectively positionable in a first operating position and a second stored position.

2. The hand truck of claim 1, further comprising a fourth caster disposed on said main body, wherein a second pair of the casters is disposed on a second end of said main body opposite said first end and adapted to be unidirectional.

3. The hand truck of claim 2, wherein the first pair of the casters is disposed at an angle relative to a longitudinal axis of said main body.

4. The hand truck of claim 2, wherein the first paid of the casters is disposed parallel to a longitudinal axis of said main body.

5. The hand truck of claim 1, wherein the first pair of the casters is multi-directional.

6. The hand truck of claim 1, further comprising a first slot with a détente disposed adjacent thereto, the slot formed adjacent one of the channels, wherein the détente releasably stores said handle assembly in the second stored position.

7. A hand truck comprising:
a main body having a substantially planar upper surface, a bottom, a pair of spaced apart apertures formed in a first end of said main body, a pair of spaced apart channels formed in opposing sides of said main body, a pocket formed in said main body adjacent one of the channels, a slot formed adjacent at least one of the channels, a détente disposed adjacent the slot, and at least three casters disposed on the bottom of said main body, wherein a first pair of the casters is disposed on a first end of said main body; and
a handle assembly including a pair of spaced apart arms joined by a handle portion, wherein each of the arms include a first end pivotally disposed in one of the apertures of said main body, said handle assembly selectively positionable in a first operating position and a second stored position, wherein the détente releasably stores said handle assembly in the second stored position.

8. The hand truck of claim 7, further comprising a fourth caster disposed on the bottom of said main body, wherein a second pair of said casters is disposed on a second end of said main body.

9. The hand truck of claim 8, wherein all of the casters are disposed at an angle relative to the longitudinal axis of said main body.

10. The hand truck of claim 8, wherein one of the first paid and the second pair of the casters are parallel to the longitudinal axis of said main body.

11. The hand truck of claim 8, wherein the first pair of the casters is multi-directional.

12. The hand truck of claim 8, wherein the second pair of the casters is unidirectional.

13. The hand truck of claim 8, wherein all of the casters are multi-directional.

14. A hand truck comprising:
a main body having a substantially planar upper surface, a bottom, a pair of spaced apart apertures formed in a first end of said main body, a pair of spaced apart channels formed in opposing sides of said main body, a pocket formed in said main body adjacent one of the channels, a slot formed adjacent each of the channels, a détente formed adjacent each of the slots, a plurality of casters disposed on the bottom of said main body, wherein a first pair of the casters is disposed on the first end of said main body at an angle relative to a longitudinal axis of said main body and a second pair of the casters is multidirectional; and
a handle assembly including a pair of spaced apart arms joined by a handle portion, wherein each of the arms includes a first end pivotally disposed in one of the apertures of said main body, said handle assembly selectively positionable in a first operating position and a second stored position, and wherein the détente is adapted to releasably store said handle assembly in the second stored position.

15. The hand truck of claim 14, wherein the second pair of the casters is disposed on a second end of said main body opposite the first end, the second pair of the casters is parallel to the longitudinal axis of said main body and unidirectional.

16. The hand truck of claim 14, wherein the second pair of the casters is disposed on a second end of said main body opposite the first end at an angle relative to a longitudinal axis of the main body and adapted to be multidirectional.

17. The hand truck of claim 6, further comprising a second slot with a détente disposed adjacent thereto, the slot formed adjacent another one of the channels, wherein the détente releasably stores said handle assembly in the second stored position.

18. The hand truck of claim 1, wherein said handle assembly is adapted to be locked in the first operating position.

19. The hand truck of claim 1, wherein said handle assembly is positionable only in the first operating position and the second stored position.

20. The hand truck of claim 7, wherein said handle assembly is positionable only in the first operating position and the second stored position.
